(19) United States
(12) Patent Application Publication
(10) Pub. No.: US 2004/0161730 A1
(43) Pub. Date: Aug. 19, 2004

(54) Device and method for designated hemispheric programming

(76) Inventor: John F. Urman, Arlington, VA (US)

Correspondence Address: S.W. BRICKNER & ASSOCIATES, LLC, 2001 JEFF DAVIS HWY., SUITE 1210, ARLINGTON, VA, 22202, US

(21) Appl. No.: 10/367,856

(22) Filed: Feb. 19, 2003

(51) Int. Cl. G09B 19/00

(52) U.S. Cl. 434/236

(57) ABSTRACT

A system for delivering information to a user's eyes and ears such that the information is processed most efficiently or effectively by the human brain. The system includes a field-of-view inhibiting mechanism, an audio mechanism, and a program of information formatted in accordance with left and right brain theory.

### BACKGROUND OF THE INVENTION

The present invention relates, in general, to a method and apparatus for presenting information, instructions and/or entertainment in audio and visual form in a manner that enhances learning, memorization and/or enjoyment.

It is known that the human brain processes visual and auditory information hemispherically. That is, the left and right hemispheres of the brain process information differently. The human eye contains a divided retina at the back of the eye. The retina includes a left most portion that transmits information to the left hemisphere of the brain, and a right most portion that transmits information to the right hemisphere of the brain. Through many studies conducted in which images have been flashed to one side or the other of the eyes of test participants, it has been demonstrated that images will be processed by one brain hemisphere or the other depending on which side the image was viewed. Studies have shown that the brain's left hemisphere is better at processing logical or analytical tasks, including language, while the brain's right hemisphere is better at processing artistic concepts and spatial relationships. Whether the information is presented visually or audibly, the left/right brain dichotomy appears to hold. Various devices, such as shaded contact lenses and eyeglasses, have been developed to ensure that during testing, images will be viewed by only a selected portion of the test participant's visual field. In addition, such devices have been described for use during therapy for troubled patients.

Based on the concept that the left and right hemispheres of the human brain process information differently, the present invention provides a system in which information is tailored and presented to an individual in such a way that, based on the particular characteristics of the information, the more optimal hemisphere of the brain receives the information for processing. If it is desired that the left hemisphere of the brain be addressed, the information is presented to the person's right ear and the nasal (inboard) portion of the retina of the right eye. Similarly, if the right hemisphere of the brain is to be addressed, the information is presented to the left ear and the nasal (inboard) portion of the retina of the left eye.

In any unrestricted audio and visual environment, information of interest for either the left or right hemispheres exists without discrimination. The eyes, along with ones attention, shift from one point of interest to another. Uninhibited, the visual fields sensed by the left and right components of the retina of an individual's eyes overlap. The ears may hear things spatially but it is non-selective hearing; both ears hear the same information. Because of all these factors within the audio and visual environment, information that might be processed more efficiently by one hemisphere of the brain is instead experienced by both hemispheres.

In an unrestricted audio and visual presentation, these same factors impede discrimination of left and right information. Because such a presentation is smaller than the entire environment, the present invention can address these limitations by providing a novel approach to a system for presenting targeted left and right information to a user.

The invention consists of a field-of-view (FOV) inhibiting apparatus that inhibits a portion of the visual field to which the user is attentive. The invention includes designated hemispheric programming (DHP) that is designed for use with the FOV inhibiting apparatus. The DHP creatively presents visual information tailored to the characteristics of the left and right hemispheres of the user's brain. Finally, the DHP is designed for use with existing stereo audio means to deliver dichotic audio information to the separate hemispheres of the brain of the user. Dichotic audio differs from stereo audio in that each ear hears an independent stream of audio information, thus assuring hemispheric separation. Stereo audio, on the other hand, presents audio information for one ear that contains some components of information available to the other ear.

### SUMMARY OF THE INVENTION

In accordance with the invention there is provided a method and apparatus for delivering information to the appropriate set of eye and ear such that the human brain processes the information most efficiently or effectively. More specifically, the apparatus is embodied as a field-of-view (FOV) inhibiting apparatus in the form of a head-mounted viewer having movable vanes. The vanes are adjustable, and when properly adjusted, permit a user's left and right eye to view only the information intended for that eye's nasal retinal pathway while inhibiting or blocking the temporal retinal pathway. Its purpose is to ensure that each eye will see a limited field of view of a screen or other presentation such that the left eye sees only the left side of a screen or presentation and the right eye sees only the corresponding right side of a screen or presentation. Ultimately, the left hemisphere of the brain receives the visual information displayed on the right side of the screen, and the right hemisphere receives the visual information displayed on the left side of the screen.

The present invention further includes an apparatus to present left and right dichotic audio information corresponding to the left and right visual information. This may be accomplished through the use of a user's existing stereo headphone arrangement or by an apparatus integrating the head-mounted viewer and earphones.

The present invention further includes a method for tailoring or programming the information in such a way that each hemisphere of the brain receives the information in an optimized form. This designated hemispheric programming (DHP) is designed such that this information may be delivered by a variety of means, including, for example, film, videotape, DVD, television and cable broadcast, multimedia presentation, computer program and the Internet.

### BRIEF DESCRIPTION OF THE DRAWINGS

The foregoing and other features and advantages of the present invention will become apparent from the following detailed description, taken in conjunction with the accompanying drawings, in which:

FIG. 1 schematically illustrates a first embodiment of a system for presenting information, in accordance with the present invention;

FIGS. 2A-E are various views of an embodiment of a field-of-view inhibiting apparatus which may be used in the system of FIG. 1;

FIG. 3 is a top view of an embodiment of a portion of the system of FIG. 1;

FIG. 4 is a side view of an additional embodiment of a field-of-view inhibiting apparatus that may be used in the system of FIG. 1;

FIG. 5 is a perspective view of an additional embodiment of a field-of-view inhibiting apparatus that may be used in the system of FIG. 1;

FIG. 6 is graphic depiction of a programming example that may be used in the system of FIG. 1; and,

FIGS. 7-9 are graphical depictions of screenshots that may be used in the system of FIG. 1.

### DESCRIPTION OF THE INVENTION

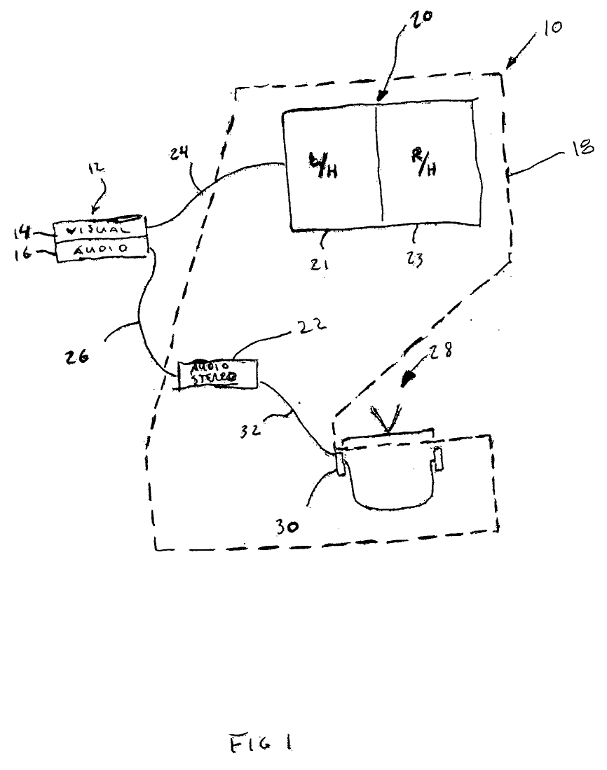

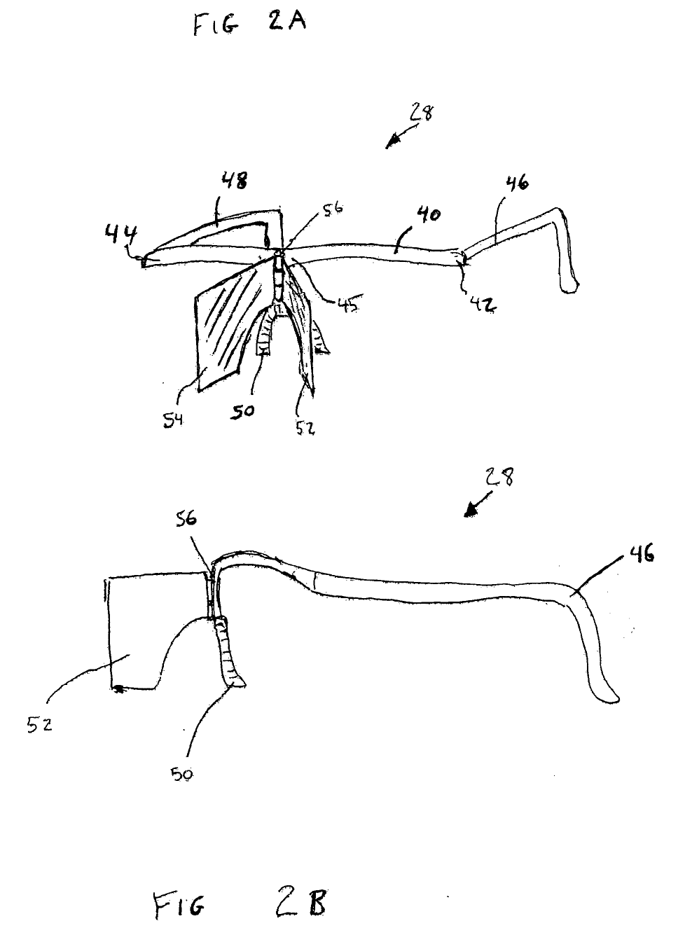

Turning now to a more detailed description of a preferred form of the invention, FIG. 1 illustrates a system 10 for presenting information to a user, not shown. The system includes a program 12 of visual information 14 and audio information 16. The program can include, for example, both fiction and non-fiction television entertainment, films, video programs, and instructional presentations, self-help media, and Internet content. A more detailed description of a representative program 12 will be included below. The visual 14 and audio 16 information is transmitted to a presentation apparatus 18 for presenting the information to a user. Presentation apparatus 18 includes a display mechanism 20 for processing and presenting visual information to a user. The display mechanism 20 is formed having a left hand display portion 21 and a right hand display portion 23. Suitable display mechanisms 20 may include, but are not limited to, video displays, such as a CRTs or television, or film or video projection screens. Presentation apparatus 18 also includes a stereo audio mechanism 22 for processing and presenting dichotic audio information to a user. Visual information 14 is depicted as being transmitted to display mechanism 20 via connection 24. Similarly, dichotic audio information 16 is depicted as being transmitted to stereo audio mechanism 22 via connection 26. These connections may be in the form of hard-wired connections, or wireless connections. Presentation apparatus 18 further includes a stereo earpiece 30 allowing a user to hear dichotic signals transmitted from stereo audio mechanism 22 via connection 32. Again, the connection may be a hard-wired or wireless connection. Finally, the system 10 also includes a field-of-view (FOV) inhibiting apparatus 28 for controlling the field-of-view of a user viewing display mechanism 20. The FOV inhibiting apparatus 28 will be described with reference to FIGS. 2A-D later.

Turning to a description of the FOV inhibiting apparatus 28, FIG. 2A depicts a head mounted viewer type apparatus intended to be worn by a user while viewing the left hand display portion 21 and the right hand display portion 23 of display mechanism 20 described above. Worn in the manner of spectacles or glasses-type mechanisms, the apparatus 28 includes a brow element 40 having end portions 42 and 44, and a central portion 45. The brow element depicted in FIG. 2A is formed as a type of headgear, including a left support arm 46 attached to end portion 42 and a right support arm 48 attached to end portion 44. The support arms 46 and 48 can be attached to the brow element 40 via a hinge or fixed attachment mechanism. In keeping with a glasses theme, the arms are preferably attached via a hinge. A nosepiece 50 is also attached to the brow element at the central portion 45. A left vane 52 and a right vane 54 are attached to the brow element 40 via a hinge 56 fixed to the central portion 45. The vanes can be adjusted to any position from a closed position, depicted in the frontal view of FIG. 2D, to an open position, depicted in the frontal view of FIG. 2E. Depending on the degree to which the vanes 52 and 54 are opened, a portion of the images viewed by the user is occluded or inhibited. More specifically, image information is prevented from falling upon the temporal, or outboard, portion of the retinas within each of the user's left and right eyes. This will be discussed below in more detail. The adjustments of interest with regard to the inventive system for presenting information will also be discussed below.

FIGS. 2B and 2C illustrate additional views of the FOV inhibiting apparatus 28, including a side view, FIG. 2B and a top-down view, FIG. 2C.

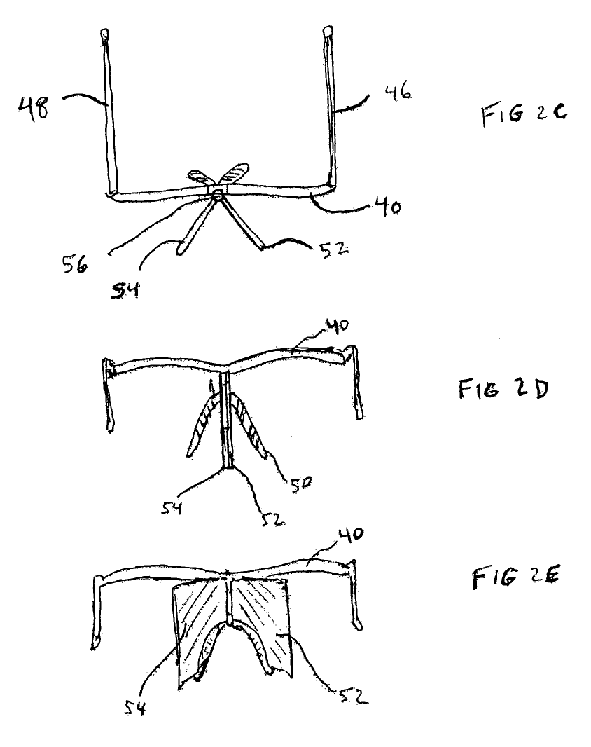

FIG. 3, not drawn to scale, depicts a top view of a user 19 using the FOV inhibiting apparatus 28 to view a display 20. Display 20 is used to present preformatted information to the user 19, via left and right hand screen portions 21, 23. The display 20 includes a centerline portion 22. As was discussed above, and as will be discussed in more detail later, the designated hemispheric programming, DHP, is designed so that information is presented to a user in such a way that each side or hemisphere of the user's brain will receive the appropriate type of information suitable for the processing associated with that particular side. Brow element 40, worn by the user includes adjustable vanes 52, 54 for inhibiting or limiting the field of view of the user's eyes. The vanes 52, 54 are depicted in their properly adjusted state. That is, the user's left eye 60 cannot view the right hand side 23 of the display 20, and the user's right eye 62 cannot view the left hand side 21 of display 20. The vanes 52, 54 are attached to the brow element 40 via, for example, a hinge 56 such that they may be angularly adjusted with respect to the brow element.

In more detail, information displayed on the left hand side 21 of display 20 is transmitted to the user's left eye 60, as illustrated using rays 64 and 66, via the eye's lens 68 that focuses the information on a retina 70 at the back of the eye. The retina is divided, forming a temporal aspect 72 and a nasal aspect 74. The drawing depicts the left vane 52 properly adjusted to an angle 75 such that information presented on the right hand side 23 of the display is blocked from view by the user's left eye 60 at point 76. Information is received by the nasal aspect 74 of the retina 70 of the user's left eye 60 and not received by the temporal aspect 72 of the retina 70 of the user's left eye 60. Similarly, information displayed on the right hand side 23 of display 20 is transmitted to the user's right eye 62, as illustrated using rays 78, 80, via the eye's lens 82 that focuses the information on the retina 84 at the back of the user's eye. The retina 84 is divided, forming a temporal aspect 86 and a nasal aspect 88. The drawing depicts the right vane 54 properly adjusted to an angle 85 such that information presented on the left hand side 21 of the display 20 is blocked from view by the user's right eye 62 at point 90. Information is received by the nasal aspect 88 of the retina 84 of the user's right eye 62 and not received by the temporal aspect 86 of the user's right eye 62.

To reiterate, information presented on the left hand side 21 of display 20 is presented to the nasal aspect 74 of the retina 70 of the user's left eye, and information presented on the right hand side 23 of display 20 is presented to the nasal aspect 88 of the retina 84 of the user's right eye. As has been shown by researchers, the nasal aspects of the left and right eye's retinas 74 and 88 are connected, respectively, to opposite brain hemispheres, 96 and 92 via optic nerve portions 100, 102, respectively. The temporal aspects 72 and 86 of the user's left and right eye's retinas, respectively, transmit information to the user's left and right brain hemispheres. The temporal aspect 72 of retina 70 of left eye 60 is connected to the left hemisphere 92 via optic nerve portion 94, and the temporal aspect 86 of retina 84 of right eye 62 is connected to the right brain 96 via optic nerve portion 98.

Generally, the screen 20 will display its content split vertically, 50% left and 50% right. Variations in screen size, the user's distance from the information presented, and variations in the width or spacing of the user's eyes will be accommodated by vanes 52, 54 on the FOV inhibiting apparatus 28. The vanes are hinged, allowing them to be spread apart or telescoped to ensure proper visual field spacing and separation. In combination with the centerline 22 of the programming aspect of the invention, they also aid in the promotion of defocusing of the user's eyes.

With regard to the audio aspects of the present invention, FIG. 3 depicts a user 19 wearing an earpiece apparatus 30 consisting of a left speaker 102 and a right speaker 104 connected to an audio stereo device 22 via connections 106 and 108 respectively. Dichotic audio information provided to the left ear 110 of the user 19 is transmitted to the right hemisphere of the brain 96 via auditory pathway 112. Similarly, dichotic audio information provided to the right ear 114 of the user is transmitted to the left brain portion 92 via auditory pathway 116.

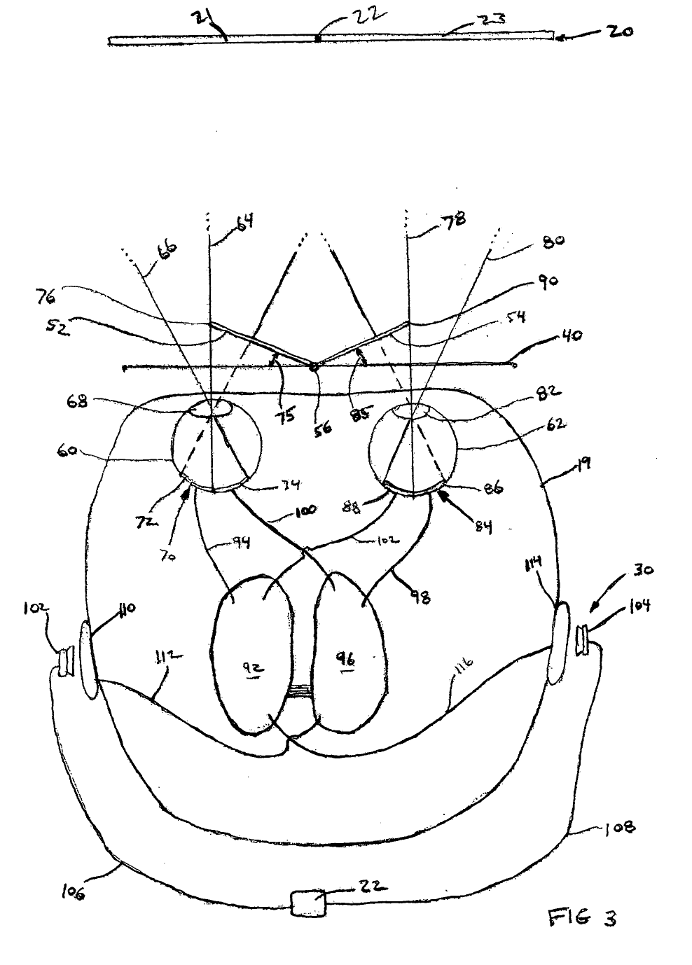

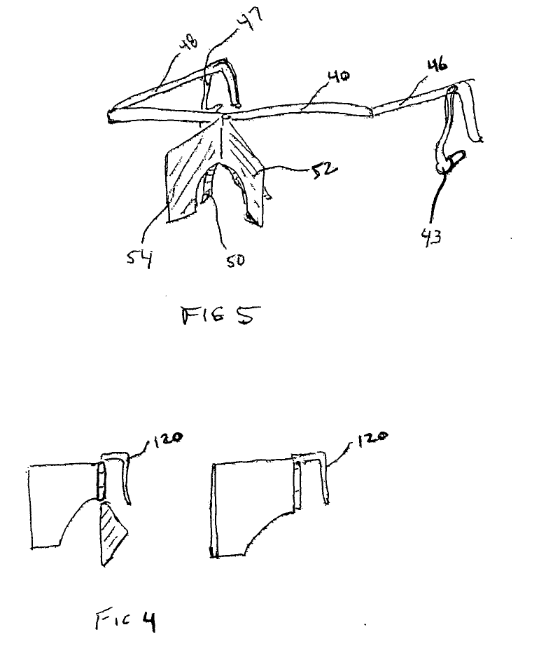

In addition to the specific embodiment described above, other variations can provide an appropriate field-of-view blocking. For example, one variation, depicted in FIG. 4, will attach to a user's existing glasses via a clip 120 or some other suitable attaching means. The clip-on version performs the same function as the headgear above, and allows the use of an individual's existing glasses framework. In addition, FIG. 5 depicts a glasses or spectacles type framework combined with integral stereo earpieces 43, 47.

Programming, in the form of video tapes, DVD's, broadcast media, Internet content and other similar processes that will be viewed and listened to by the user, is designed to create an engaged and receptive user. Once a subject has been chosen, a decision regarding program length, including breaks, is made. Decisions must then be made to ensure proper formatting for targeting hemispheres. For example, visual attributes are considered. Such attributes can be, for example, general, descriptive or temporal. General attributes describe characteristics like background, mid-ground, foreground, text, detail, color, brightness, contrast, size, position, color, and opacity. Also, overlays, graphics and other effects are considered. Descriptive attributes can be, for example, font, wording, meaning, appearance, mood, overtness and subliminalness. Temporal attributes relate to the temporal flow of the program and can include, for example, dissolves, timing, rhythm, pacing and pattern. Similarly, audio attributes are considered. They may include, for example, echo, reverb, intonation, vocalization, volume, bass, treble, timbre, tempo, rhythm, beat, effect, graphic equalization, and spatial and temporal relationships.

To each item on the list of visual and audio attributes, a decision is made as to whether that attribute will be synchronous, synonymous, or asynchronous to its counterpart being delivered to the opposite hemisphere. The decision on how different or how similar one is to the other is guided by an understanding of left and right brain theory. For example, synchronous information may be presented initially during the program. That is, the video and audio information of the left side is identical and contemporaneous with that of the right side. As the program continues, slight changes in wording, in both audio and visual form, and changes in imagery, create synonymous information. Synonymous information occurs when the visual and audio information of the left side differs yet means the same as that of the right side.

The progression of the programming is designed to create initial acceptance of the information presented to the user. As the program advances, the user will be led to a state of receptivity while the brain is engaged in the content. In this regard, the width of the area that separates the left and right visual information can be controlled to encourage defocusing of the eyes to help create the state of receptivity in the user.

The decisions regarding formatting are made on an instant-by-instant, or frame-by-frame basis, in consideration of the desired look, feel, and flow of the program. Changes are possible at any point in the creative process.

Once the creative decisions are made, the program can be rendered onto an appropriate media. As has been mentioned above, information, instructions and/or entertainment is presented in audio and visual form. Left and right dichotic audio will arrive by headphones or “ear buds” ensuring that audio information intended for processing by the left side of the brain is heard by the right ear and audio information intended for processing by the right side of the brain is heard by the left ear. This will work in conjunction with the FOV inhibiting apparatus to ensure corresponding visual information intended for processing by the left side of the brain is displayed on the right side of a screen and only seen by the nasal portion of the retina of the right eye, and visual information intended for processing by the right side of the brain is displayed on the left side of a screen and seen only by the nasal portion of the retina of the left eye.

A sample, representative program, in conjunction with related Figures, will now be described. The program provides written instructions for basic layout, text and timing in a manner that will be familiar to those skilled in the art. Of particular interest with respect to the subject invention, the described program includes dual, left and right sets of programming instructions.

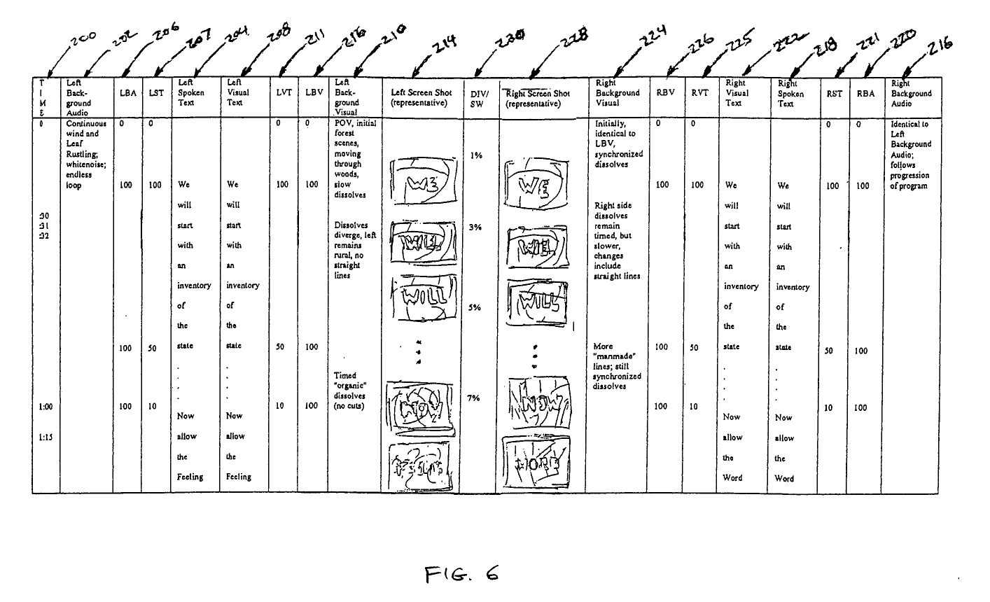

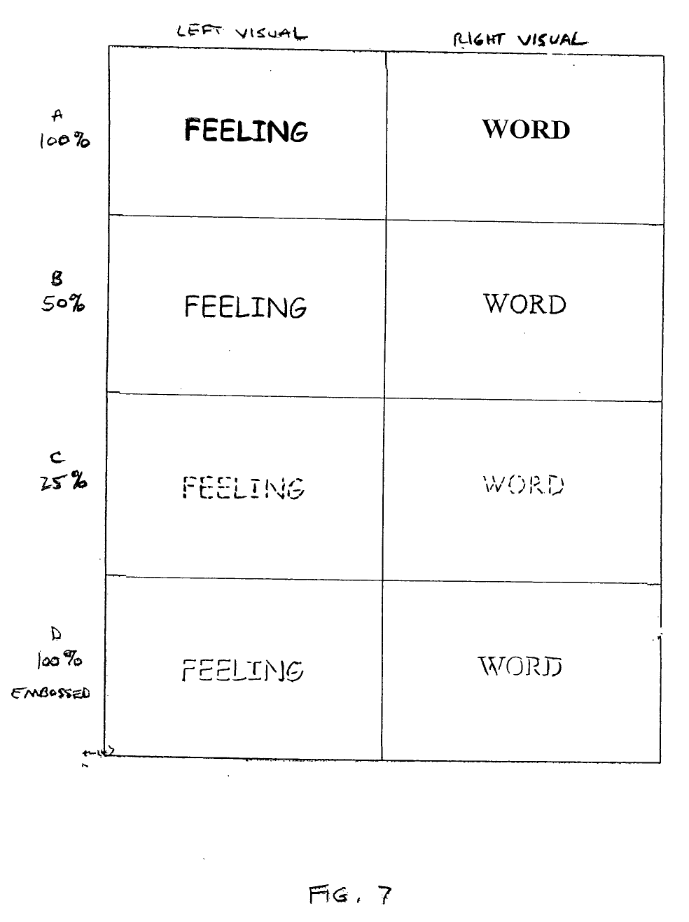

FIG. 6 provides a graphical display of examples used in the following program description. The figure is a description of the initial portion of a program, and depicts a timeline, including the relative level of background and foreground visual information, the relative levels of background and foreground audio information, and spatial relationships at different points in time. Time column 200 depicts the relative passage of time, including specific points in time of interest to the programmer. The Left Background Audio 202 and Left Spoken Text 204 columns describe what is to be heard by a user through the left side audio. For example, Left Background Audio column 202 indicates that the program provides for a background audio of continuous wind and leaf rustling, while Left Spoken Text column 204 indicates spoken text heard by the user. LBA column 206 and LST column 207 are provided to indicate the relative levels of the left background audio and left spoken text, respectively, to be played into the left audio channel. In this example, the levels are indicated on a scale from 0 to 100, minimum to maximum. For example, at the start of the program, time 0, a 0 in each of the LBA 206 and LST 207 columns indicates that the sound levels are set at a minimum level. As the program progresses, spoken text is introduced into the left audio channel, as depicted in Left Spoken Text column 204, and background audio is introduced into the left audio channel, as depicted in Left Background Audio column 202. At first, these sounds are introduced at a full level, indicated 100. Later, the left spoken text is lowered in level, first to a mid-level, indicated 50, then subsequently to an even lower value, indicated 10. Left Visual Text 208 and Left Background Visual 210 columns describe what is to be displayed on the left side of the display screen. For example, the program starts with a left background visual of a “point of view” passage through a forest setting. Text is displayed on the screen, in this particular program, in time with the left spoken text. LVT column 211 and LBV column 212 are provided to indicate the relative intensities or levels of left visual text and left background visual, respectively, as seen by the user. For example, initially the program begins with no text and no background visual displayed, as is indicated by 0 in each of the LVT 211 and LBV 212 columns. Subsequently, text is displayed keyed over the background visual, each at a full level, indicated 100. Later, the left visual text is lowered in level, first to a mid-level, indicated 50, then to an even lower level, indicated 10. The Left Screen Shot column 214 depicts representative screen shots at given points in time. Although this column is usually not necessary, the depicted screen shots in this example provide a storyboard effect that helps the programmer visualize that which the user is supposed to see. Information displayed on the left side of the display is intended for processing by the right hemisphere of the user's brain. Thus, as described in the Left Background Visual column 210 and depicted in the Left Screen Shot column 214, images displayed should be “organic” or “natural”, without straight lines. This will be described in more detail later in the discussion regarding FIGS. 7-9.

The Right Background Audio 216 and Right Spoken Text 218 columns describe what is to be heard by a user through the right side audio channel. For example, Right Background Audio column 216 indicates that the program provides for a right background audio identical to the left background audio, i.e. the sound of continuous wind and leaf rustling, while Right Spoken Text column 218 indicates spoken text heard by the user. RBA column 220 and RST column 221 are provided to indicate the relative levels of right background audio and right spoken text, respectively, to be played into the right audio channel. For example, at the start of the program, time 0, a 0 in each of the RBA 220 and RST 221 columns indicates that the sound levels are set at a minimum level. As the program progresses, spoken text is introduced into the right audio channel, as depicted in Right Spoken Text column 218, and background audio is introduced into the right audio channel, identical to the Left Background Audio. At first, these sounds are introduced at a full level, indicated 100. Later, the right spoken text is lowered in level, first to a mid-level, indicated 50, then subsequently to an even lower level, indicated 10. Right Visual Text 222 and Right Background Visual 224 columns describe what is to be displayed on the right side of the display screen. For example, the program starts with a right background visual identical to that of the left background visual described previously, i.e. a “point of view” passage through a forest setting. Text is displayed on the screen, in this particular program, in time with the right spoken text. RVT column 225 and RBV column 226 are provided to indicate the relative intensities or levels of right visual text and right background visual, respectively, as seen by the user. For example, initially the program begins with no text and no background visual displayed, as is indicated by 0 in each of the RVT 225 and RBV columns. Subsequently, text is displayed keyed over the background visual, each at a full level, indicated 100. Later, the right visual text is lowered in level, first to a mid-level, indicated 50, then to an even lower level, indicated 10. The Right Screen Shot column 228 depicts representative screen shots at given points in time. As was described above, this column is usually not necessary, although the depicted screen shots provide a storyboard effect that helps the programmer visualize that which the user is supposed to see. The information displayed on the right side of the display is intended to be processed by the left hemisphere of the user's brain. Thus, as described in Right Background Visual column 224 and depicted in Right Screen Shot column 228, images displayed should be “manmade” in appearance, with straight lines. Again, this will be described in more detail later in the discussion regarding FIGS. 7-9.

The DIV/SW column 230 provides an indication of the relative amount of centerline division, DIV, with respect to the screen width, SW. For example, depending on a user's familiarity with using the subject invention, or depending on the specific type of information to be presented to a user, more or less centerline division may be necessary to ensure proper left/right separation. The DIV/SW column 230 provides guidelines with regard to the centerline division.

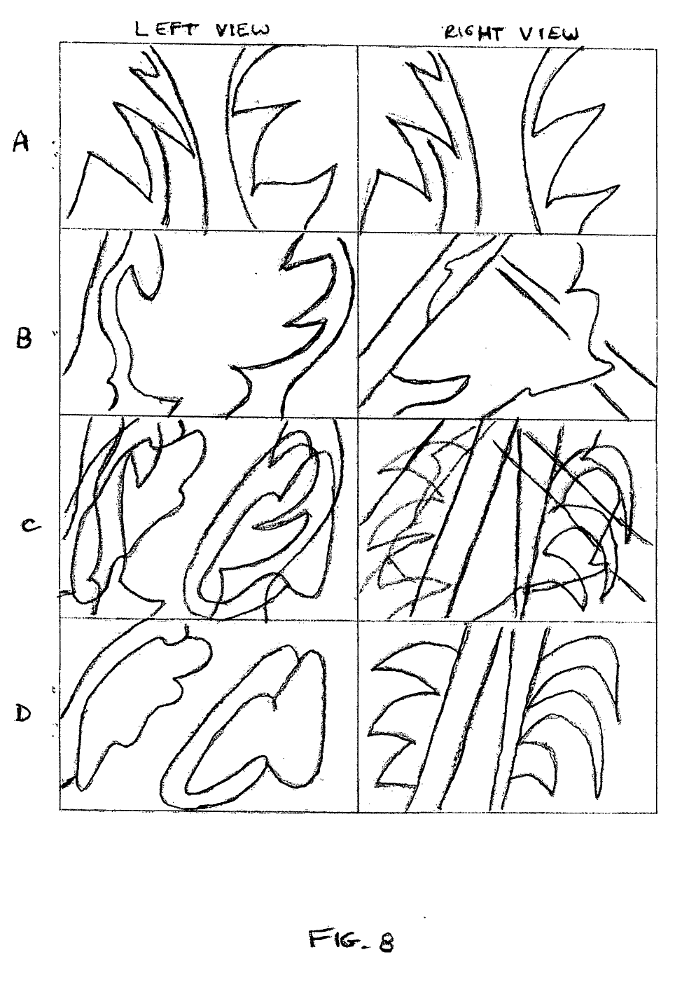

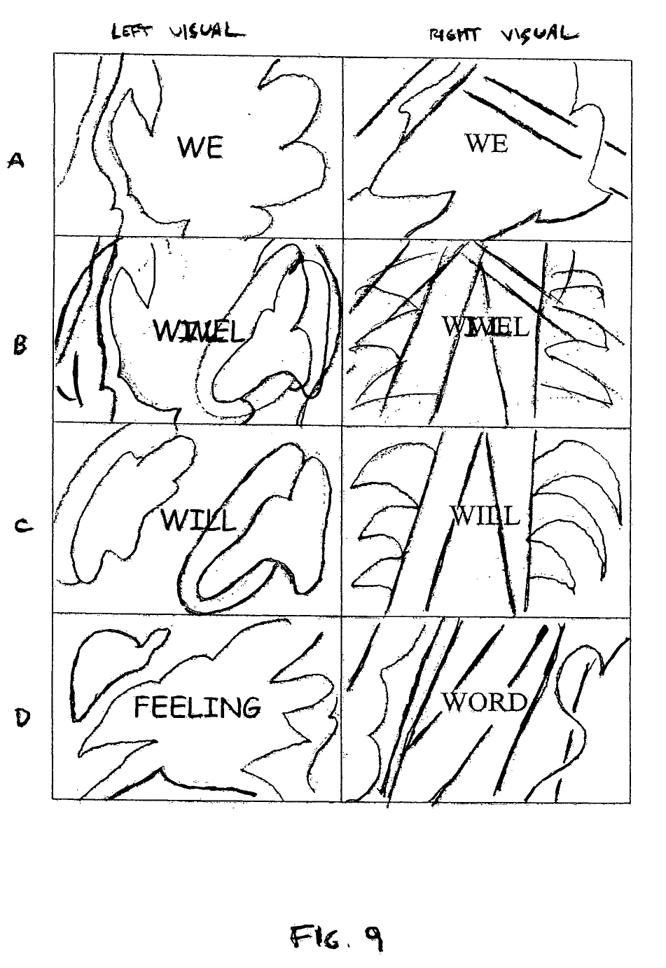

FIGS. 7-9 graphically depict representative screenshots described in the program description. FIG. 7 depicts left and right visual text becoming more subliminal as the program progresses. FIG. 8 depicts background visual information including examples of synchronous and synonymous information and dissolves between images. FIG. 9 provides examples of the background visual information and foreground textual information, both with dissolves, and including an example of synchronous background and text.

What follows is a sample program for Subliminal Suggestion and Self-Help. Comments not normally provided in such a program description are interspersed with program text below to provide clarification of some of the concepts described.

Sample Program for Subliminal Suggestion and Self-Help Approximate Run Time: 6 Min.

LEFT VISUAL: Consists of film, video, and/or computer-generated Steadicam-type footage of forest scenes flowing past a point-of-view perspective. Care is taken to show only natural scenery with few or no straight lines. Dissolves are to be smooth and as seamless as possible to provide an uninterrupted flow. Text is keyed on top in overt, solid lettering and follows the designated left synonymous text. Font is chosen for lack of straight lines, and as “organic” as possible. As the program progresses, the text becomes less and less solid and takes on the appearance as seen on network “bugs” e.g. FOX, TLC. Such appearance will be in transparent shadow or transparent drop-shadow form.

RIGHT VISUAL: Again film, video, or computer-generated Steadicam-type footage of scenery flowing past a point-of-view perspective. Scenery allows straight lines and man-made objects and images. Text is keyed on top in overt, solid lettering and follows the designated right synonymous text. Font is chosen to be similar to the left font, but allows more straight lines. As the program progresses the text follows the progression of appearance of the left text.

At this point, notice that FIG. 8 depicts the forest scenes described above. Left and Right panel views change as time progresses. Panel A depicts the left and right views are of the same scene, i.e. synchronous. Panel B depicts related, yet dissimilar “synonymous” visual information. Panel C depicts a dissolve from panel B to panel D, with panel D depicting a new “synonymous” scene.

FIG. 7 depicts left and right visual text becoming subliminal as the program progresses. Notice that the displayed text starts out at 100% density, panel A, and eventually progresses to a transparent shadow appearance.

FIG. 9 depicts left and right visual text keyed on top of the background view. Starting with panel A, a synonymous background is provided with synchronous text. Although two different fonts are used, the text is identical. Panel B provides an example of a dissolve from panel A to panel C. Panel C depicts a completed dissolve, resulting in synonymous background and synchronous text. Panel D depicts an example of synonymous background and synonymous text.

LEFT AUDIO: Spoken instruction will follow visual text as designated for the left hemisphere through synonymous word choice. Background sound may be of non-specific identity. That is, “white noise”, sounds of sea surf, restaurant babble, etc. Spoken audio is initially overt and obvious to the listener. As the program progresses, it becomes less evident and more subliminal to the background audio and thus more subliminal to the user.

RIGHT AUDIO: Spoken instruction will follow visual text as designated for the right hemisphere through synonymous word choice. Background sound is identical to the left background audio and follows its progression through the program.

FIG. 6 depicts the relationship between the spoken audio, the background audio, and the various screenshots formed over time, including text and background images.

CENTER DIVISION: Pre-striped and black in color to match the color of the viewing apparatus vanes. May become wider as the program progresses to facilitate de-focusing of the eyes.

In the following program text, synonymous information is shown in the form: “L/R text/text”. Hence, “L/R feeling/word” means that the word “feeling” is spoken in the left L audio and displayed on the left screenview, while at the same time, the word “word” is spoken in the right R audio and displayed on the right screenview.

Body of the Text

“We will start with an inventory of the state of your body. Begin by noticing your head and how it feels now. Next, notice how your shoulders and back feel. Continue and feel how your whole upper body feels. Now, notice how your hips and legs and feet feel. Notice how your entire lower body feels. Now put it all together and notice your whole body in its entirety and how it feels.

Now focus on your hands that are resting on your thighs. Notice how they feel. The feeling has a word, and the word is heavy. Your hands feel heavy on your thighs. Silently repeat the word heavy and notice the feeling and the word together. The feeling and the word are one and the same. Begin to allow the L/R feeling/word to pass from your hands into your lower body. Down through your hips, thighs, legs, knees, calves, ankles, and then to your feet. The L/R feeling/word is now filling your feet and toes.

Now the L/R feeling/word is moving upwards. As it moves upwards each part of your body lets go and relaxes as it passes. From your feet up your ankles and calves and knees and upwards past legs, thighs, hips and into the stomach and lower back. All of your body is relaxing as it passes. As it reaches your lungs, the L/R feeling/word becomes L/R connected/synchronous to your breathing. Your breathing and the L/R feeling/word become one. Now that the L/R feeling/word has become a part of your body, you L/R can/will change the L/R feeling/word into L/R peaceful/calm. As you inhale, L/R peaceful/calm moves upward and fills your neck, your jaw, your face, your eyes, and your forehead. As you relax as it fills your head, know that you are in a place of L/R comfort/safety. You will know that you have permission to live a L/R peaceful/serene life in the face of L/R adversity/trouble.

Knowing that that is true, you will now return from this place of L/R comfort/safety and bring this knowledge with you. You will count from 1 to 5. When you reach 5 you will be wide awake, alert and ready to face the day. 1 . . . 2 . . . 3 . . . 4 . . . 5 Eyes wide open, you are wide awake, and feeling fantastic.”

In the above programming example, there are, of course, L and R components of both visual and audio information. In the case of audio information, the L and R dichotic components are combined with the background audio. The background audio is the same for the L and R ear. However, in the visual part, the L and R components are combined with a L and R background visual. The purpose of this arrangement of apparatus and programming is to induce a state of acceptance by initially presenting the audio information congruent and synchronous with the visual information. As the presentation progresses, the use of synonymous information, both audio and video, induces a state of suggestibility and light hypnosis, providing an enhanced effectiveness for imparting information.

Alternatively, an example of a variation of the programming would be to present the separate L and R visual components with a single, full-screen background visual component. This allows the user to view an apparent single image while maintaining the delivery of L and R targeted information. In this variation, the FOV inhibiting apparatus would still be worn, a center line is laid over any appropriate full-screen video, and the L and R components are then “keyed” over the video. Keyed is a term of art in television describing overlaying one video over another i.e. video mixing. In this case, the background image is not L or R. Clinically, the video seen by both eyes still combines into one picture because of the corpus callossum, the neural pathways which allow the exchange of information between hemispheres. However, use of the field-of-view inhibiting device allows L and R targeted components to still address the separate hemispheres at a subliminal level. The extra milliseconds it takes for the background visual information to exchange between hemispheres allows the L and R targeted information to remain effective.

An additional variation relates to the center division. The division in the above programming example is pre-striped and black in color to match the color of the viewing apparatus vanes. Also, as described above, the division may become wider as the program progresses to facilitate de-focusing of the eyes. With use over a period of time, a user of the inventive system may benefit from a disappearing line. Such a system may be more user-friendly for some users. A user may find that the learning curve evolves such that a user needs it less and less over time and by habit remains in appropriate position to separate the hemispheric L and R components.

In an additional variation, the benefits and advantages provided by the present invention, as discussed above, may be accomplished without using a stereo means to deliver dichotic audio information. Providing visual information tailored to the characteristics of the left and right hemispheres of a user's brain, without audio, should not negate the positive effects described above. In fact, hearing-impaired individuals may experience an enhanced benefit using only the visual information given their enhanced visual acuity resulting from a loss of their sense of hearing.

By utilizing these and other techniques, the invention can enhance the entertainment value of books, plays, movies, television programming and other such works. Educational programs such as academic classes and product instruction will be improved. Enhancements extend to the area of self-help programming such as those for weight loss, smoking cessation, relaxation and increased self-esteem. Delivery via Internet is possible, as are websites containing any of the aforementioned uses.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

What is claimed is:

1. A system for presenting information to a user such that the user's distinct left and right brain functions will be optimally used to process the information, the system comprising:
a program of visual information preformatted in accordance with left and right brain function theory;
means for presenting said program of visual information to the user; and,
a field of view inhibiting apparatus utilized by the user to ensure said program's visual information is viewed by the user for optimum left and right brain function.

2. The system of claim 1 wherein said means for presenting said program's visual information includes a display screen having a left portion for displaying information intended to be processed by the user's right brain, and a right portion for displaying information intended to be processed by the user's left brain.

3. The system of claim 2 wherein said field of view inhibiting apparatus further comprises:
a horizontal brow element having a first end, a second end, and a central portion;
a nosepiece attached to said horizontal brow element at said central portion;
a left vane element pivotally attached on a vertical axis to said central portion of said brow element, said left vane element angularly adjustable to block the view of the user's left eye to the information displayed on said right portion of said display screen; and,
a right vane element pivotally attached on a vertical axis to said central portion of said brow element, said right vane element angularly adjustable to block the view of the user's right eye to the information displayed on said left portion of said display screen.

4. The system of claim 3 wherein said field of view inhibiting apparatus further comprises a left support arm attached to said brow element at said first end and a right support arm attached to said brow element at said second end.

5. The system of claim 1 wherein said field of view inhibiting apparatus further comprises:
a horizontal brow element having a first end, a second end, and a central portion;
a nosepiece attached to said horizontal brow element at said central portion;
a left vane element pivotally attached on a vertical axis to said central portion of said brow element, said left vane element angularly adjustable to block the view of the user's left eye to the information displayed on said right portion of said display screen; and,
a right vane element pivotally attached on a vertical axis to said central portion of said brow element, said right vane element angularly adjustable to block the view of the user's right eye to the information displayed on said left portion of said display screen.

6. The system of claim 5 wherein said field of view inhibiting apparatus further comprises a left support arm attached to said brow element at said first end and a right support arm attached to said brow element at said second end.

7. The system of claim 1 further comprising:
a program of audio information preformatted in accordance with left and right brain function theory; and,
means for presenting said program of audio information.

8. The system of claim 7 wherein said means for presenting said program of audio information comprises a stereo audio means.

9. The system of claim 8 wherein said stereo audio means comprises left and right earpieces worn by the user to ensure said program of audio information is heard by the user for optimum left and right brain function.

10. The system of claim 7 wherein said means for presenting said program's visual information includes a display screen having a left portion for displaying information intended to be processed by the user's right brain, and a right portion for displaying information intended to be processed by the user's left brain.

11. The system of claim 10 wherein said field of view inhibiting apparatus further comprises:
a horizontal brow element having a first end, a second end, and a central portion;
a nosepiece attached to said horizontal brow element at said central portion;
a left vane element pivotally attached on a vertical axis to said central portion of said brow element, said left vane element angularly adjustable to block the view of the user's left eye to the information displayed on said right portion of said display screen; and,
a right vane element pivotally attached on a vertical axis to said central portion of said brow element, said right vane element angularly adjustable to block the view of the user's right eye to the information displayed on said left portion of said display screen.

12. The system of claim 11 wherein said field of view inhibiting apparatus further comprises a left support arm attached to said brow element at said first end and a right support arm attached to said brow element at said second end.

13. The system of claim 7 wherein said field of view inhibiting apparatus further comprises:
a horizontal brow element having a first end, a second end, and a central portion;
a nosepiece attached to said horizontal brow element at said central portion;
a left vane element pivotally attached on a vertical axis to said central portion of said brow element, said left vane element angularly adjustable to block the view of the user's left eye to the information displayed on said right portion of said display screen; and,
a right vane element pivotally attached on a vertical axis to said central portion of said brow element, said right vane element angularly adjustable to block the view of the user's right eye to the information displayed on said left portion of said display screen.

14. The system of claim 13 wherein said field of view inhibiting apparatus further comprises a left support arm attached to said brow element at said first end and a right support arm attached to said brow element at said second end.

15. A method for presenting information to a user such that the user's distinct left and right brain functions will be optimally used to process the information, comprising the steps of:
providing a program of visual information preformatted in accordance with left and right brain function theory;
presenting said program of visual information to the user; and,
providing a field of view inhibiting apparatus for use by the user to ensure said program's visual information is viewed for optimum left and right brain function.

16. The method of claim 15 wherein providing said program of visual information includes the additional steps of:
selecting a first set of visual attributes to best optimize left brain processing;
selecting a second set of visual attributes to best optimize right brain processing;
formatting left visual information in accordance with said first set of visual attributes;
formatting right visual information in accordance with said second set of visual attributes; and,
arranging said left and right visual information to be synchronous, synonymous or asynchronous with respect to each other in accordance with left and right brain function theory.

17. The method of claim 16 wherein said visual attributes are chosen from general attributes, descriptive attributes, and temporal attributes.

18. The method of claim 15 including the additional steps of:
providing a program of audio information preformatted in accordance with left and right brain function theory; and,
presenting said program of audio information.

19. The method of claim 18 wherein providing said program of audio information includes the additional steps of:
selecting a first set of audio attributes to best optimize left brain processing;
selecting a second set of audio attributes to best optimize right brain processing;
formatting left audio information in accordance with said first set of audio attributes;
formatting right audio information in accordance with said second set of audio attributes; and,
arranging said left and right audio information to be synchronous, synonymous or asynchronous with respect to each other in accordance with left and right brain function theory.

20. The method of claim 15 wherein presenting said program of visual information includes the additional steps of:
providing a display screen having left and right portions;
selecting a centerline separation between the left and right portions to enhance the user's receptivity of visual information;
displaying on the left portion of the display screen information intended to be processed by the user's right brain; and,
displaying on the right portion of the display screen information intended to be processed by the user's left brain.

21. The method of claim 20 including the additional step of:
angularly adjusting the field of view inhibiting apparatus such that the user's left eye cannot view the right portion of the display screen and the user's right eye cannot view the left side of the display screen.

22. A method for presenting information to a user such that the user's distinct left and right brain functions will be optimally used to process the information, comprising the steps of:
A. providing a program of visual information preformatted in accordance with left and right brain function theory, including the steps of:
selecting a first set of visual attributes to best optimize left brain processing;
selecting a second set of visual attributes to best optimize right brain processing;
formatting left visual information in accordance with said first set of visual attributes;
formatting right visual information in accordance with said second set of visual attributes;
arranging said left and right visual information to be synchronous, synonymous or asynchronous with respect to each other in accordance with left and right brain function theory;
B. presenting said program of visual information to the user including the steps of:
providing a display screen having left and right portions;
selecting a centerline separation between the left and right portions to enhance the user's receptivity of visual information;
displaying on the left portion of the display screen information intended to be processed by the user's right brain;
displaying on the right portion of the display screen information intended to be processed by the user's left brain;
C. providing a field of view inhibiting apparatus for use by the user to ensure said program's visual information is viewed for optimum left and right brain function; and,
D. angulary adjusting the field of view inhibiting apparatus such that the user's left eye cannot view the right portion of the display screen and the user's right eye cannot view the left side of the display screen.

23. The method of claim 22 including the additional steps of:
A. providing a program of audio information preformatted in accordance with left and right brain function theory including the steps of:
selecting a first set of audio attributes to best optimize left brain processing;
selecting a second set of audio attributes to best optimize right brain processing;
formatting left audio information in accordance with said first set of audio attributes;
formatting right audio information in accordance with said second set of audio attributes;
arranging said left and right audio information to be synchronous, synonymous or asynchronous with respect to each other in accordance with left and right brain function theory; and,
B. presenting said program of audio information.
